(19) United States
(12) Patent Application Publication
(10) Pub. No.: US 2018/0281289 A1
(43) Pub. Date: Oct. 4, 2018

(54) THREE-DIMENSIONAL OBJECT MODELING DEVICE, METHOD OF MOLDING THREE-DIMENSIONAL OBJECT, AND CONTROL PROGRAM FOR THREE-DIMENSIONAL OBJECT MODELING DEVICE

(71) Applicant: Seiko Epson Corporation, Tokyo (JP)

(72) Inventor: Satoshi YAMAZAKI, Matsumoto (JP)

(21) Appl. No.: 15/903,483

(22) Filed: Feb. 23, 2018

(30) Foreign Application Priority Data
Mar. 28, 2017 (JP) 2017-062246

(51) Int. Cl. B29C 64/393; B29C 64/209; B29C 64/106; B33Y 30/00

(52) U.S. Cl. CPC B29C 64/393; B33Y 30/00; B29C 64/106; B29C 64/209

(57) ABSTRACT

A three-dimensional object modeling device includes a model data generator that generates model data including a color of the three-dimensional object; a region determiner that determines a color region to be colored by the coloring ink, and a model region that is inwardly of the color region and to be modeled by the modeling ink, based on the generated model data; a first discharge data generator that generates discharge data of the modeling ink in the model region; a second discharge data generator that generates discharge data of the coloring ink while limiting formation of the dot with the coloring ink in the color region to less than or equal to a unit thickness of modeling using the coloring ink and the modeling ink; and a processing controller that causes the modeling ink and the coloring ink to be discharged using the generated discharge data.

### BACKGROUND

### 1. Technical Field

The present invention relates to a modeling technique for a three-dimensional object.

### 2. Related Art

Three-dimensional (3D) printers are known as three-dimensional object modeling devices. The three-dimensional (3D) printer described in JP-A-2016-93913 discharges ink, forms a layered model body with dots formed by the discharged ink, and layers the layered model body, thereby modeling a three-dimensional object. An ink layer is formed by coloring ink on the surface of the three-dimensional object.

In the above-described technique, an insufficient volume due to use of coloring ink only is filled by clear ink, and thus shape reproducibility is improved. However, sufficient consideration has not been given to improvement of the external appearance of the three-dimensional object to be modeled, for instance, improvement of color reproducibility, or both color reproducibility and shape reproducibility.

### SUMMARY

An advantage of some aspects of the invention is that at least one of the above-mentioned problems can be coped with, and the invention may be implemented according to one of the following aspects.

(1) In an aspect of the invention, there is provided a three-dimensional object modeling device that uses ink which is solidified after being discharged, and becomes part of a three-dimensional object as a three-dimensional dot. The three-dimensional object modeling device includes: a first nozzle that allows a modeling ink in the ink to be discharged, the modeling ink being used for modeling the three-dimensional object; a second nozzle that allows a coloring ink in the ink to be discharged, the coloring ink being used for coloring the three-dimensional object; a model data generator that generates model data including a color of the three-dimensional object; a region determiner that determines a color region to be colored by discharge of the coloring ink through the second nozzle, and a model region that is inwardly of the color region and to be modeled by discharge of the modeling ink through the first nozzle, based on the generated model data; a first discharge data generator that generates discharge data of the modeling ink for discharging the modeling ink in the model region; a second discharge data generator that generates discharge data of the coloring ink while limiting formation of the dot with the coloring ink in the color region to less than or equal to a unit thickness of modeling using the coloring ink and the modeling ink; and a processing controller that causes the modeling ink and the coloring ink to be discharged though the first and second nozzles using the generated discharge data of the modeling ink and the generated discharge data of the coloring ink. According to the aspect, discharge data of the coloring ink is generated while formation of the dot with the coloring ink in the color region is limited to less than or equal to a unit thickness of modeling using the coloring ink and the modeling ink, thus, high color reproducibility can be achieved while maintaining the shape reproducibility.

(2) In the aspect, the second nozzle may include a plurality of second nozzles for discharging a plurality of coloring inks having different hues, the coloring ink being one of the plurality of coloring inks, and the second discharge data generator may determine the formation of the dot with the coloring ink in accordance with a predetermined priority order of the plurality of coloring inks having different hues. According to the aspect, the formation of the dot with the coloring ink is determined in accordance with a predetermined priority order of the plurality of coloring inks having different hues, thus, the color reproducibility can be improved.

(3) In the aspect, the second discharge data generator may assign a higher priority order to a coloring ink with a lower brightness among the plurality of coloring inks having different hues. According to the aspect, a higher priority order is assigned to a coloring ink with a lower brightness, thus, the color reproducibility can be improved.

(4) In the aspect, the second nozzle allows the plurality of coloring inks to be discharged coping with dots in a plurality of sizes, and the second discharge data generator may assign a priority order to discharge coping with a large dot among the dots in the plurality of sizes, the priority order being higher than the priority order of the coloring ink with a lower brightness. According to the aspect, the priority order assigned to discharge coping with a large dot is higher than the priority order of the coloring ink with a lower brightness, thus, the color reproducibility can be further improved.

(5) In the aspect, the second discharge data generator may determine a dot to be layered in the color region, by halftone processing so that a predetermined amount of ink or less is used for the dot, and when an amount of ink layered in the color region is less than the predetermined amount of ink, the second discharge data generator may determine to fill an insufficiency with ink other than the coloring ink. According to the aspect, when an amount of ink layered in the color region is less than the predetermined amount of ink, an insufficiency is filled by ink other than the coloring ink, thus, the shape reproducibility can be improved.

The invention can be implemented in various aspects, and for instance, can be implemented as a method of modeling a three-dimensional object, and a control program for a three-dimensional object modeling device in addition to a three-dimensional object modeling device.

### BRIEF DESCRIPTION OF THE DRAWINGS

The invention will be described with reference to the accompanying drawings, wherein like numbers reference like elements.

FIG. 1 is a functional block diagram illustrating the configuration of a three-dimensional object model system.

FIG. 2 is a perspective view schematically illustrating the internal structure of a three-dimensional object modeling device.

FIG. 3 is an explanatory diagram illustrating a recording head.

FIG. 4 is a flowchart of generation of ink discharge data executed by a CPU of a host computer.

FIG. 5 is an explanatory diagram illustrating part of a three-dimensional object when the three-dimensional object is cut along the xy plane.

FIG. 6 is a flowchart illustrating an example of processing when a region determiner determines a transparent layer, a color layer, a shield layer, and a model layer in step S110 of FIG. 4.

FIG. 7 is a flowchart of color value assignment processing performed by a discharge data generator in step S120 of FIG. 4.

FIG. 8 is an explanatory diagram schematically illustrating the processing performed in step S126, S140.

FIG. 9 is a flowchart illustrating model processing performed by the three-dimensional object modeling device.

FIG. 10 is an explanatory diagram illustrating the sizes of dots in another embodiment.

FIG. 11 is a flowchart of color value assignment processing performed by the discharge data generator.

FIG. 12 is an example of graph schematically illustrating the processing in step S123, performed by the discharge data generator.

FIG. 13 is an explanatory diagram illustrating an example of dot generation processing in step S129 of FIG. 11, performed by the discharge data generator.

FIG. 14 is an explanatory diagram illustrating an example of dot generation processing in step S129 of FIG. 11, performed by the discharge data generator.

### DESCRIPTION OF EXEMPLARY EMBODIMENTS

Hereinafter, an embodiment for carrying out the invention will be described with reference to the drawings. However, in each drawing, the dimensions and scale of each component are made different from actual ones as needed. Also, the embodiments described below are preferred specific examples, and thus technically preferable various limitations are imposed. However, the scope of the invention is not limited to those embodiments unless particularly described to limit the invention in the following description.

### First Embodiment

In this embodiment, an ink jet three-dimensional object modeling device, which discharges curable ink (an example of “liquid”) such as resin ink containing a resin emulsion, or ultraviolet curable ink to model a three-dimensional object Obj, will be illustrated and described as a three-dimensional object modeling device.

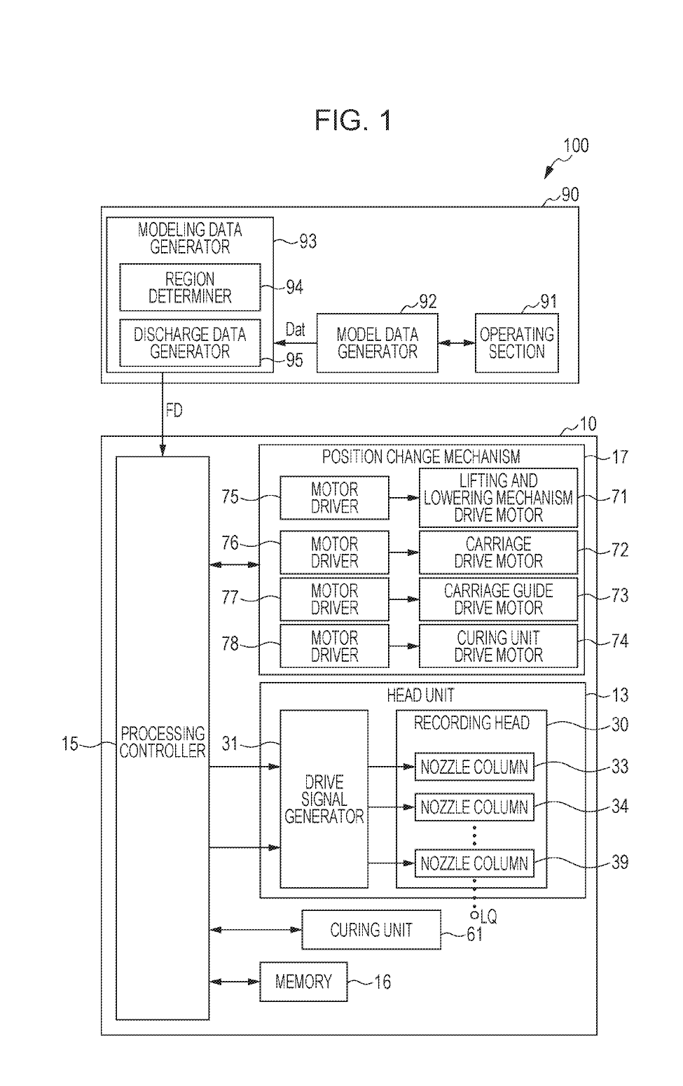

FIG. 1 is a functional block diagram illustrating the configuration of a three-dimensional object modeling system 100. As illustrated in FIG. 1, the three-dimensional object modeling system 100 includes a host computer 90 that generates data for modeling a three-dimensional object, and a three-dimensional object modeling device 10 that models a three-dimensional object. The three-dimensional object modeling device 10 discharges ink, forms a layered model body with a predetermined thickness using the dots formed by solidifying the discharged ink, and layers the model body, thereby performing model processing to model the three-dimensional object Obj. The host computer 90 executes data generation processing for generating modeling data FD that defines the shape and color of each of multiple model bodies included in the three-dimensional object Obj modeled by the three-dimensional object modeling device 10.

As illustrated in FIG. 1, the host computer 90 includes a CPU (not illustrated) that controls the operation of each component of the host computer 90, a display unit (not illustrated) such as a display, an operating part 91 such as a keyboard and a mouse, an information memory (not illustrated) that stores a control program of the host computer 90, a driver program of the three-dimensional object modeling device 10, and application programs, such as a computer aided design (CAD) software, a model data generator 92 that generates model data Dat, and a modeling data generator 93 that performs data generation processing for generating modeling data FD based on the model data Dat.

Here, the model data Dat is data that indicates the shape and color of a model representing the three-dimensional object Obj to be modeled by the three-dimensional object modeling device 10, and that is for specifying the shape and color of the three-dimensional object Obj. It is to be noted that hereinafter the color of the three-dimensional object Obj includes the manner in which the multiple colors are applied when multiple colors are applied to the three-dimensional object Obj, that is, patterns, characters, and other images represented by the multiple colors applied to the three-dimensional object Obj.

The model data generator 92 is a functional block that is implemented by executing an application program by the CPU of the host computer 90, the application program being stored in the information memory. The model data generator 92 is, for instance, a CAD application, and generates model data Dat which specifies the shape and color of the three-dimensional object Obj, based on information inputted via an operation of the operating part 91 by a user of the three-dimensional object model system 100. A user may also read model data Dat to the host computer 90, the model data Dat being created by another computer.

It is to be noted that in this embodiment, it is assumed that the model data Dat specifies the external shape and the surface color of the three-dimensional object Obj. In other words, it is assumed that the model data Dat specifies the shape of the three-dimensional object Obj which is assumed to be hollow, that is, the contour shape of the three-dimensional object Obj. For instance, when the three-dimensional object Obj is a sphere, the model data Dat indicates the spherical shape that is the contour of the sphere. However, the invention is not limited to such aspects and it is sufficient that the model data Dat include information that can identify at least the external shape of the three-dimensional object Obj. For instance, in addition to the external shape and color of the three-dimensional object Obj, the model data Dat may specify the internal shape and material of the three-dimensional object Obj. For instance, a data format, such as an additive manufacturing file format (AMF) and a standard triangulated language (STL) can be exemplified as the model data Dat.

The model data generator 93 is a functional block that is implemented by executing a driver program of the three-dimensional object modeling device 10 by the CPU of the host computer 90, the driver program being stored in the information memory. The model data generator 93 is a model region determiner, and performs data generation processing for generating modeling data FD that defines the shape and color of a model body to be formed by the three-dimensional object modeling device 10, based on the model data Dat generated by the model data generator 92.

In the following, it is assumed that the three-dimensional object Obj is modeled by laminating Q layered model bodies (Q is a natural number satisfying Q≥2). Also, in the following, processing of forming a model body performed by the three-dimensional object modeling device 10 is referred to as layer processing. In other words, model processing for modeling the three-dimensional object Obj performed by the three-dimensional object modeling device 10 includes the layer processing for Q times.

In order to generate Q pieces of modeling data FD that define the shape and color of Q model bodies each having a predetermined thickness, the model data generator 93 first generates sectional model data that has a one-to-one correspondence with each model body by slicing a three-dimensional shape indicated by the model data Dat every predetermined thickness Lz. Here, the sectional model data is data that indicates the shape and color of each section body obtained by slicing the three-dimensional shape indicated by the model data Dat. However, the sectional model data may be data that includes the shape and color of the section when the three-dimensional shape indicated by the model data Dat is sliced. The thickness Lz corresponds to the length of the dots formed by solidifying ink in the height direction.

Next, in order to form a model body corresponding to the shape and color indicated by the sectional model data, the model data generator 93 determines the arrangement of dots to be formed by the three-dimensional object modeling device 10, and outputs a result of the determination as the model data. In other words, the modeling data FD refers to data that, when the shape and color indicated by the sectional model data are expressed as a set of dots by subdividing the shape and color into a lattice, specifies the type of ink for forming each of multiple dots. The modeling data FD may include data that indicates the size of dots. Here, each dot is a three-dimensional object that is formed by solidifying the ink discharged at a time. In this embodiment, for the sake of convenience, each dot is a rectangular parallelepiped or a cube that has a predetermined thickness Lz and a predetermined volume. Also, in this embodiment, the volume and size of each dot are determined by factors including a pitch of the nozzle through which ink is discharged, a discharge interval of ink, and a viscosity of ink.

The model data generator 93 includes a region determiner 94, and a discharge data generator 95. The region determiner 94 determines a region in which dots formed by the coloring ink are arranged among the dots to be formed by the three-dimensional object modeling device 10. The region determiner 94 determines a color region in which coloring is performed by discharging coloring ink to the surface of a set of dots formed by modeling ink, so as to reduce the difference in the depth in a normal direction of the surface of the three-dimensional object Obj. For instance, it is assumed that the variation in the depth from the surface of a color region is constant. In addition, the region determiner 94 determines a model region in which modeling is performed by discharging modeling ink inwardly of the color region. How to determine a color region and a model region will be described later. The discharge data generator 95 has functions as a first discharge data generator that generates modeling ink discharge data for discharging modeling ink, and a second discharge data generator that generates coloring ink discharge data for discharging coloring ink. When coloring ink discharge data is generated, the discharge data generator 95 performs halftone processing. The details of the halftone processing will be described later.

As described above, the model data Dat according to this embodiment specifies the external shape (contour shape) of the three-dimensional object Obj. For this reason, when a three-dimensional object Obj in the shape indicated by the model data Dat is faithfully modeled, the shape of the three-dimensional object Obj is a hollow shape with the only contour having no thickness. However, when a three-dimensional object Obj is modeled, it is preferable to determine the shape inside the three-dimensional object Obj in consideration of the strength of the three-dimensional object Obj. Specifically, when a three-dimensional object Obj is modeled, it is preferable that part or all of the inside of the three-dimensional object Obj have a solid structure. For this reason, the model data generator 93 according to this embodiment generates modeling data FD indicating that part or all of the inside of the three-dimensional object Obj has a solid structure regardless of whether or not the shape specified by the model data Dat is a hollow shape.

It is to be noted that depending on the shape of the three-dimensional object Obj, no dot is present in the (n−1)th layer which a lower layer of the dots in the nth layer. In such a case, even when a dot in the nth layer is attempted to be formed, the dot may fall downward. Thus, when “q≥2”, in order to form a dot for constructing a model body at a position where the dot is to be formed originally, it is necessary to provide a supporter below the dot for supporting the dot. In this embodiment, similarly to the three-dimensional object Obj, a supporter is formed by dots composed of solidified ink. Thus, in this embodiment, in addition to the three-dimensional object Obj, the modeling data FD includes data for forming dots to form a supporter which is necessary when the three-dimensional object Ob is modeled. That is, in this embodiment, the model body includes both a portion in the three-dimensional object Obj to be formed by the qth layer processing, and a portion in the supporter to be formed by the qth layer processing. In other words, the modeling data FD includes data in which the shape and color of a portion formed as a model body in the three-dimensional object Obj are represented as a set of dots, and data in which the shape of a portion formed as a model body in the supporter are represented as a set of dots. The model data generator 93 according to this embodiment determines whether or not a supporter has to be provided for forming dots, based on the sectional model data or the model data Dat. When a result of the determination is affirmative, the model data generator 93 generates modeling data FD for providing a supporter, in addition to the three-dimensional object Obj. It is to be noted that it is preferable that the supporter be composed of a material that can be easily removed after the formation of the three-dimensional object Obj, for instance, water-soluble ink. The ink for forming dots used for the supporter is called “support ink”.

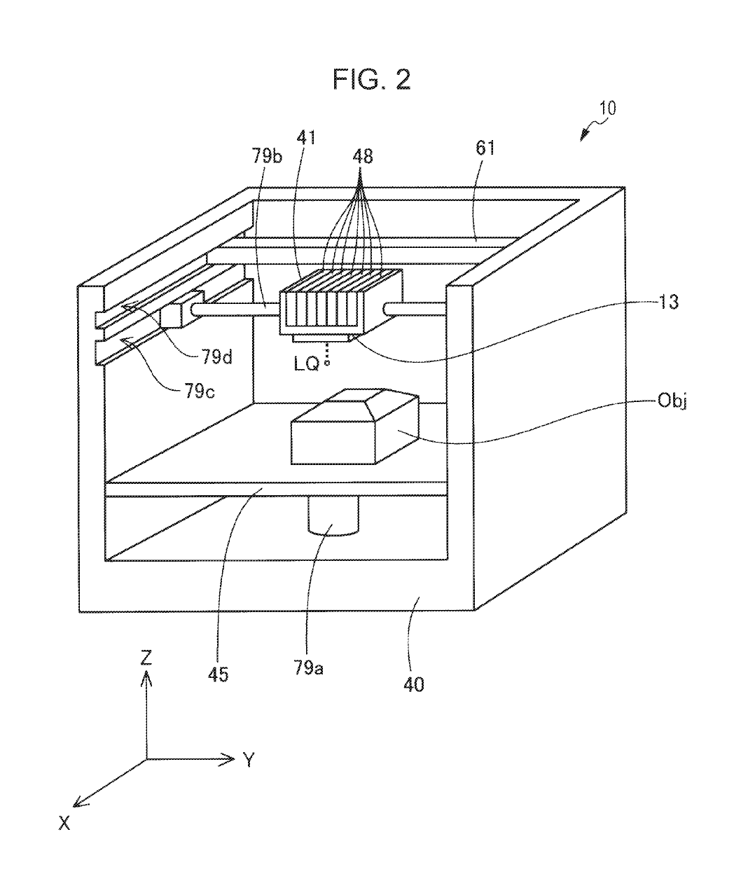

FIG. 2 is a perspective view schematically illustrating the internal structure of the three-dimensional object modeling device 10. Hereinafter, a description is given with reference to FIG. 1 in addition to FIG. 2. As illustrated in FIGS. 1 and 2, the three-dimensional object modeling device 10 includes a housing 40, a model table 45, a processing controller 15 (an example of “model controller”) that controls the operation of each component of the three-dimensional object modeling device 10, a head unit 13, a curing unit 61, a carriage 41, a position change mechanism 17, and a memory 16 that stores a control program of the three-dimensional object modeling device 10 and other various pieces of information. The carriage 41 is equipped with the head unit 13 and seven ink cartridges 48. The head unit 13 includes a recording head 30 including nozzle columns 33 to 39, and discharges ink liquid droplet LQ to the model table 45 through the nozzle columns 33 to 39. The curing unit 61 is for curing the ink discharged onto the model table 45. The position change mechanism 17 changes the positions of the carriage 41, the model table 45, and the curing unit 61 with respect to the housing 40. The processing controller 15 and the model data generator 93 each serve as a system controller that controls the operation of each component of the three-dimensional object model system 100.

The curing unit 61 is a component that cures the ink discharged onto the model table 45, and for instance, a light source for irradiating ultraviolet curing ink with ultraviolet rays, and a heater for heating resin ink can be illustrated. When the curing unit 61 is a light source of ultraviolet rays, the curing unit 61 is provided, for instance, on the upper side (in +Z direction) of the model table 45. On the other hand, when the curing unit 61 is a heater, the curing unit 61 may be provided, for instance, on the inner side of the model table 45 or on the lower side of the model table 45. Hereinafter, a description is given under the assumption that the curing unit 61 is a light source of ultraviolet rays and the curing unit 61 is positioned in +Z direction of the model table 45.

Seven ink cartridges 48 are provided to have a one-to-one correspondence with totally seven types of ink of the modeling ink with six different hues for modeling the three-dimensional object Obj, and supporting ink (support ink) for forming a supporter. Each of the ink cartridges 48 is filled with ink of a type corresponding to the ink cartridge 48. The modeling ink with six colors for modeling the three-dimensional object Obj includes chromatic color ink having a chromatic color material component, achromatic color ink having an achromatic color material component, and clear (CL) ink having a less content of color material component per unit weight or unit volume as compared with the chromatic color ink and the achromatic color ink. In this embodiment, inks in three colors of cyan (CY), magenta (MG), and yellow (YL) are used as the chromatic color ink. Also, in this embodiment, inks of white (WT) and black (K) are used as the achromatic color ink. In this embodiment, the chromatic color ink and the black ink are collectively called “coloring ink”. The white ink according to this embodiment is an ink that, when the white ink is irradiated with light having a wavelength belonging to a wavelength range (approximately 400 nm to 700 nm) of visible light, reflects light with a predetermined ratio or higher in the light with which the white ink is irradiated. It is to be noted that “reflects light with a predetermined ratio or higher” is synonymous with “absorbs or transmits light with less than a predetermined ratio”, and refers to a situation when a ratio of the quantity of light reflected by the white ink to the quantity of light with which the white ink is irradiated is higher than or equal to a predetermined ratio, for instance. In this embodiment, the “predetermined ratio” may be, for instance, any ratio 30% or higher and 100% or lower, and is preferably any ratio of 50% or higher, and is more preferably any ratio of 80% or higher. In this embodiment, the clear ink is a highly transparent ink having a less content of color material component as compared with the chromatic color ink and the achromatic color ink.

It is to be noted that each ink cartridge 48 may be provided somewhere else in the three-dimensional object modeling device 10 other than in the carriage 41.

As illustrated in FIGS. 1 and 2, the position change mechanism 17 includes a lifting and lowering mechanism drive motor 71, carriage drive motors 72, 73, a curing unit drive motor 74, and motor drivers 75 to 78. The position change mechanism 17 receives an instruction from the processing controller 15, and drives a model table lifting and lowering mechanism 79a that lifts and lowers the model table 45 in +Z direction and −Z direction (hereinafter, +Z direction and −Z direction may be collectively referred to as the “Z-axis direction”). The carriage drive motor 72 receives an instruction from the processing controller 15, and moves the carriage 41 along a guide 79b in +Y direction and −Y direction (hereinafter, +Y direction and −Y direction may be collectively referred to as the “Y-axis direction”). The carriage drive motor 73 receives an instruction from the processing controller 15, and moves the carriage 41 along a guide 79c in +X direction and −X direction (hereinafter, +X direction and −X direction may be collectively referred to as the “X-axis direction”). The curing unit drive motor 74 receives an instruction from the processing controller 15, and moves the curing unit 61 along a guide 79d in +X direction and −X direction. The motor driver 75 drives the lifting and lowering mechanism drive motor 71, the motor drivers 76, 77 drive the carriage drive motors 72, 73, and the motor driver 78 drives the curing unit drive motor 74.

The head unit 13 includes a recording head 30 and a driving signal generator 31. The driving signal generator 31 receives an instruction from the processing controller 15, and generates various signals including a driving waveform signal for driving the recording head 30, and a waveform specification signal, and outputs these generated signals to the recording head 30. A description of the driving signal generator 31 and the driving waveform signal will be omitted.

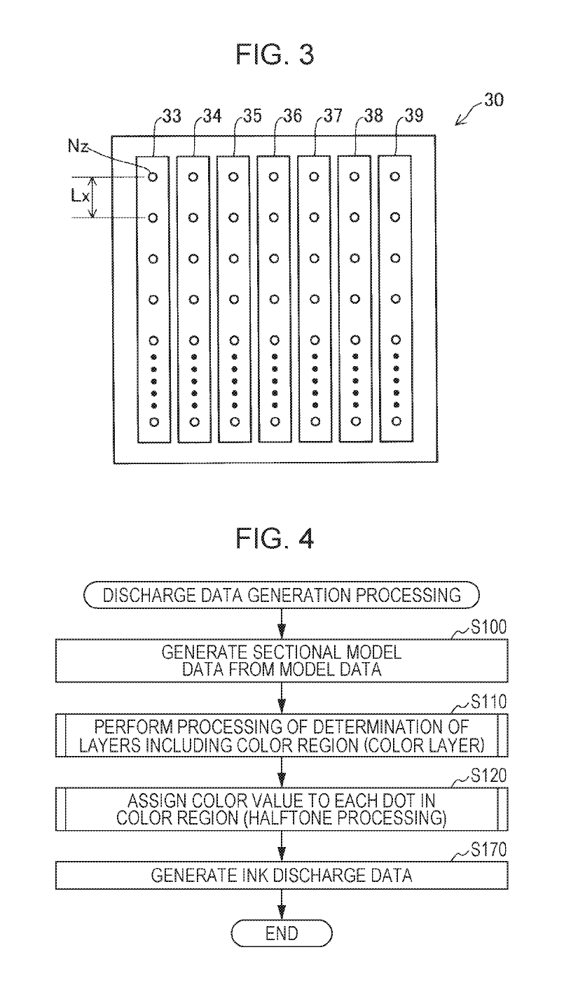

FIG. 3 is an explanatory diagram illustrating the recording head 30. The recording head 30 includes seven nozzle columns 33 to 39. Each of the nozzle columns 33 to includes multiple nozzles Nz provided at intervals of pitch Lx. The nozzle columns 33 to 35 have nozzles Nz for discharging the chromatic color inks (cyan, magenta, yellow) each of which is coloring ink. The nozzle columns 36, 37 have nozzles Nz for discharging ink of white (also called “white ink”) which is achromatic color ink, and ink of black. The nozzle column 38 has nozzles Nz for discharging of clear ink. The nozzle column 39 has nozzles Nz for discharging the support ink. Here, all inks except the support ink are used as the modeling ink, and the chromatic color ink and the black ink are used as the coloring ink. Therefore, the first nozzle, through which the modeling ink is discharged, includes the nozzles Nz in the nozzle columns 33 to 38, and the second nozzle, through which the coloring ink is discharged, includes the nozzles Nz in the nozzle columns 33 to 36, and 38.

In this embodiment, as illustrated in FIG. 3, the nozzles Nz in the nozzle columns 33 to 39 are arranged so as to be aligned in a row in the X-axis direction. However, for instance, part of the nozzles Nz (for instance, even-numbered nozzles Nz) and the other part of the nozzles Nz (for instance, odd-numbered nozzles Nz) may be at different positions in the Y-axis direction, that is, so-called in a staggered configuration among multiple nozzles Nz included in the nozzle columns 33 to 39. Also, the interval (pitch Lx) between nozzles Nz in the nozzle columns 33 to 39 may be set as appropriate according to a dot per inch (DPI).

The processing controller 15 includes a central processing unit (CPU) and a field-programmable gate array (FPGA), and controls the operation of each component of the three-dimensional object modeling device 10 by operating the CPU in accordance with the control program stored in the memory 16. The memory 16 includes an electrically erasable programmable read-only memory (EEPROM) which is a type of a non-volatile semiconductor memory that stores the modeling data FD supplied from the host computer 90; a random access memory (RAM) that temporarily stores data necessary for performing various types of processing, such as model processing to model a three-dimensional object Obj, or allows a control program for controlling each component of the three-dimensional object modeling device 10 to be temporarily loaded so as to perform various types of processing, such as the model processing; and a PROM which is a type of a non-volatile semiconductor memory that stores control programs.

The processing controller 15 controls the operation of the head unit 13 and the position change mechanism 17 based on the modeling data FD supplied from the host computer 90, thereby controlling the execution of the model processing to model the three-dimensional object Obj on the model table 45 according to the model data Dat. Specifically, the processing controller 15 first stores the model data FD supplied from the host computer 90 in the memory 16. Next, the processing controller 15 controls the driving signal generator 31 of the head unit 13, generates various signals including a driving waveform signal for driving the recording head 30 and a waveform specification signal, and outputs these generated signals to the recording head 30, based on various types of data such as the modeling data FD stored in the memory 16. Also, the processing controller 15 generates various signals for controlling the motor drivers 75 to 78, outputs these generated signals to the motor drivers 75 to 78, and controls the relative position of the head unit 13 with respect to the model table 45, based on various types of data such as the modeling data FD stored in the memory 16.

In this manner, the processing controller 15 controls the relative position of the head unit 13 with respect to the model table 45 via control of the motor drivers 75, 76, and 77, and controls the relative position of the curing unit 61 with respect to the model table 45 via control of the motor drivers 75 and 78. In addition, the processing controller 15 controls presence and absence of discharge of ink through the nozzles Nz, the amount of discharge of ink, and the timing of discharge of ink via control of the head unit 13. Thus, the processing controller 15 forms dots on the model table 45 while adjusting the size of dots and arrangement of dots which are formed by the ink discharged onto the model table 45, and controls the execution of layer processing for forming a model body by curing the dots formed on the model table 45. In addition, the processing controller 15 repeatedly performs the layer processing to layer a new model body on a model body already formed, thereby controlling the execution of model processing for forming a three-dimensional object Obj corresponding to the model data Dat.

FIG. 4 is a flowchart of generation of ink discharge data executed by the CPU of the host computer 90. The processing is executed by a CPU corresponding to the model data generator 93, after the model data Dat is created by the model data generator 92 of the host computer 90. When the processing is started, in step S100, the model data generator 93 generates sectional model data from the model data Dat. In step S110 subsequent to step S100, the region determiner 94 determines a color region. Specifically, the region determiner 94 determines dots DT to be composed of coloring ink among the dots DT included in each layer. It is to be noted that the region determiner 94 determines not only a color region, but also a transparent layer, a shield layer, and a model layer. In step S120 subsequent to step S110, the discharge data generator 95 performs halftone processing for assigning a color value to each dot. In the subsequent step S170, the discharge data generator 95 generates ink discharge data in a format corresponding to the modeling data FD.

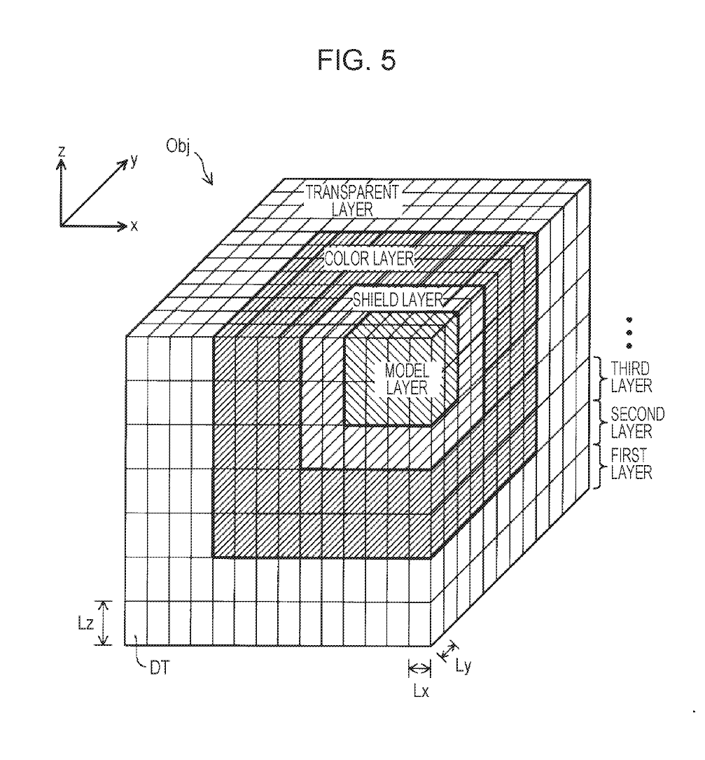

FIG. 5 is an explanatory diagram illustrating part of the three-dimensional object Obj when the three-dimensional object Obj is cut along the xy plane. The model data generator 93 forms the shape of the three-dimensional object Obj as a set of dots DT each having a three-dimensional shape with length, width, height of Ly, Lx, Lz. In this embodiment, Ly:Lx:Lz is equal to 1:1:2. Here, Lx is the length of each dot DT in the x direction, and is equal to the pitch of the nozzles Nz. Ly is the length of each dot DT in the y direction, and is equal to a movement length of the recording head 30 according to a discharge interval of ink. Lz is equal to the length of each dot DT in the z direction. Lz is determined by the viscosity and amount of ink of which each dot is composed. The sectional model data of each layer is formed, for instance, as a set of dots DT disposed two-dimensionally in the x direction and the y direction. It is to be noted that each dot DT forms one of the later-described transparent layer, color layer (color region), shield layer, and model layer.

The three-dimensional object Obj has a model layer at the center. The model layer forms the main shape of the three-dimensional object Obj. The model layer may be formed using any ink other than the support ink. A shield layer is formed on the surface of the model layer. The shield layer is for shielding the model layer to make the color thereof invisible, and is composed of white ink. The thickness of the shield layer is L3. A color layer is formed on the surface of the shield layer. The color layer is a color region, and a color is applied to the three-dimensional object Obj. The color layer is composed of chromatic color ink and white ink. Here, when the gradation of the chromatic color ink is low, a region, to which the chromatic color ink is not applied, may occur. Since the chromatic color ink also forms the shape, a shape loss may occur in the region to which the chromatic color ink is not applied. The white ink fills the region to which the chromatic color ink is not applied, and reduces the possibility of occurrence of a shape loss. It is to be noted that clear ink may be used instead of the white ink. The thickness of the color layer is L2. A transparent layer is for protecting the color layer, and is composed of the clear ink which is a transparent ink. The thickness of the transparent layer is L1. It is to be noted that the transparent layer may not be provided.

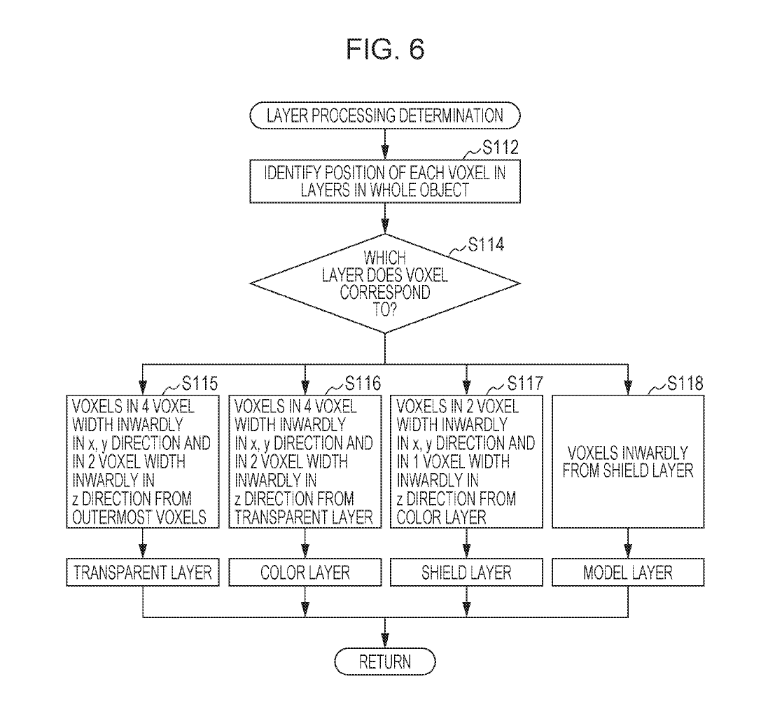

FIG. 6 is a flowchart illustrating an example of processing when the region determiner 94 determines a transparent layer, a color layer, a shield layer, and a model layer in step S110 of FIG. 4. In step S112, the region determiner 94 identifies the position of each voxel in each layer in the whole three-dimensional object Obj. The position of each voxel can be identified in terms of the number of voxels in the x direction, the y direction, and the z direction from a reference voxel which is one of voxels. In the next step S114, the region determiner 94 determines that each voxel is which one of a transparent layer, a color layer, a shield layer, and a model layer. Specifically, the region determiner 94 determines a transparent layer, a color layer (color region), a shield layer, and a model layer in that order. In step S115, the region determiner 94 determines that the voxels that form a transparent layer are defined by the region inwardly by length L1 from the outermost voxel, specifically, the voxels in 4 voxel width in the x, y direction, and the voxels in 2 voxel width in the z direction. The reason why the number of voxels in the z direction is half the number of voxels in the x, y direction is because Lx:Ly:Lz=1:1:2, and thus the length Lz of each voxel in the z direction is twice the length Lx of each voxel in the x direction and twice the length Ly of each voxel in the y direction. Subsequently, in step S116, the region determiner 94 determines that the voxels that form a color layer are defined by the region inwardly by length L2 from the transparent layer, specifically, the voxels in 4 voxel width in the x, y direction, and the voxels in 2 voxel width in the z direction. Subsequently, in step S117, the region determiner 94 determines that the voxels that form a shield layer are defined by the region inwardly by the length L2 from the color layer, specifically, the voxels in 2 voxel width in the x, y direction, and the voxels in 1 voxel width in the z direction. Subsequently, in step S118, the region determiner 94 determines that the voxels that form a model layer are defined by the voxels inwardly of the shield layer. In this embodiment, the transparent layer, the color layer (color region), the shield layer, and the model layer are determined by the number of voxels, however, may be determined by a distance L1 from the contour, a distance L2 from the inner surface of the transparent layer, and a distance L3 from the inner surface of the color layer. The above-described processing determines the arrangement of voxels of the transparent layer, the color layer, the shield layer, and the model layer that form the three-dimensional object Obj indicated by the internal structure illustrated in FIG. 5. It is to be noted that the number of voxels, four and two are an example.

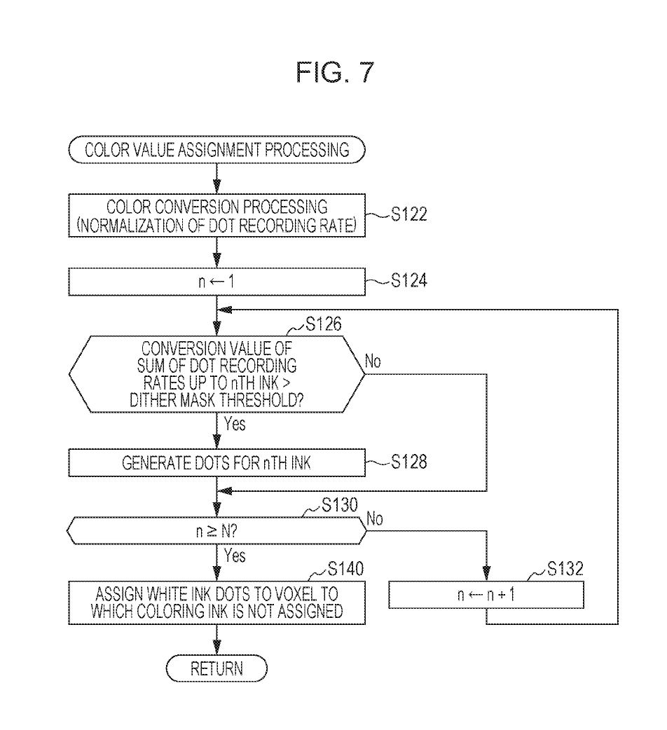

FIG. 7 is a flowchart of color value assignment processing performed by the discharge data generator 95 in step S120 of FIG. 4. When the processing is started, in step S122, the discharge data generator 95 performs color conversion processing. The color conversion processing converts RGB data owned by the sectional model data to YMCK data. The discharge data generator 95 normalizes the data in the color conversion processing so that the total of dot recording rates of the colors does not exceed 100%. The reason of normalization is that when the total of dot recording rates of the colors exceeds 100%, the size of ink when the ink is solidified exceeds the size of the three-dimensional object Obj to be modeled. For instance, when the dot recording rates of magenta, cyan, and yellow calculated from the RGB data are 50%, 30%, and 40%, respectively, the total of dot recording rates of magenta, cyan, and yellow is 120%. Here, the color obtained by mixing the same amount of magenta, cyan, and yellow is substantially black, and the discharge data generator 95 replaces 10% of each of the dot recording rates of magenta, cyan, and yellow with black. Specifically, the dot recording rate of black is set to 10%, and the discharge data generator 95 subtracts a value corresponding to the dot recording rate of black from each of the dot recording rates of the other colors. Specifically, the discharge data generator 95 subtracts 10%, that is, the dot recording rate of black from each of other dot recording rates to obtain the dot recording rate of magenta of 40% (=50−10%), the dot recording rate of cyan of 20% (=30−10%), and the dot recording rate of yellow of 30% (=40−10%). Consequently, the total of dot recording rates of black, magenta, cyan, and yellow is 100%. The discharge data generator 95 subtracts 100% from the total dot rate, and divides the result by 2 (=the number of inks−1), thereby obtaining 10% that is the dot recording rate of black.

In the subsequent step S124, 1 is substituted for variable n. The value of n corresponds to the color of ink, and in this embodiment, 1, 2, 3, and 4 correspond to black, magenta, cyan, and yellow, respectively. This is the ascending order of brightness, and is determined in advance. It is to be noted that there is no value corresponding to the white ink, and the clear ink. When a color is assigned to each dot in the ascending order of brightness, the color reproducibility can be improved.

In step S126, the discharge data generator 95 compares a conversion value of the total of dot recording rates of the 1st to nth inks with a dither mask threshold. When (the conversion value of the total of dot recording rates of the 1st to nth inks)>(the dither mask threshold), the flow proceeds to step S128, and a dot is generated in a voxel that satisfies the conversion value of the total of dot recording rates of the 1st to nth inks>the dither mask threshold. However, when a dot of (n−1)th or lower ink is already generated in the voxel, the discharge data generator 95 does not generate ink in the voxel. The processing will be described later.

In step S130, the discharge data generator 95 determines whether or not n≥N is satisfied. N is the number of the coloring inks except for the white ink. In this embodiment, N=4 because the coloring inks except for the white ink are black, magenta, cyan, and yellow. When n≥N is not satisfied, the discharge data generator 95 causes the flow to proceed to step S132, and 1 is added to n, and the flow proceeds to step S126. That is to say, the discharge data generator 95 performs the processing for the next color in step S126. When n≥N is satisfied, in other words, when generation of dots is completed for all the colors, the discharge data generator 95 causes the flow to proceed to step S140.

In step S140, the discharge data generator 95 assigns a dot of white ink to an unassigned voxel (also called “free voxel”) to which a dot of coloring ink is not assigned. When an unassigned voxel is not present, the discharge data generator 95 does not assign a white ink dot. It is to be noted that the discharge data generator 95 may assign a dot of clear ink instead of a dot of white ink.

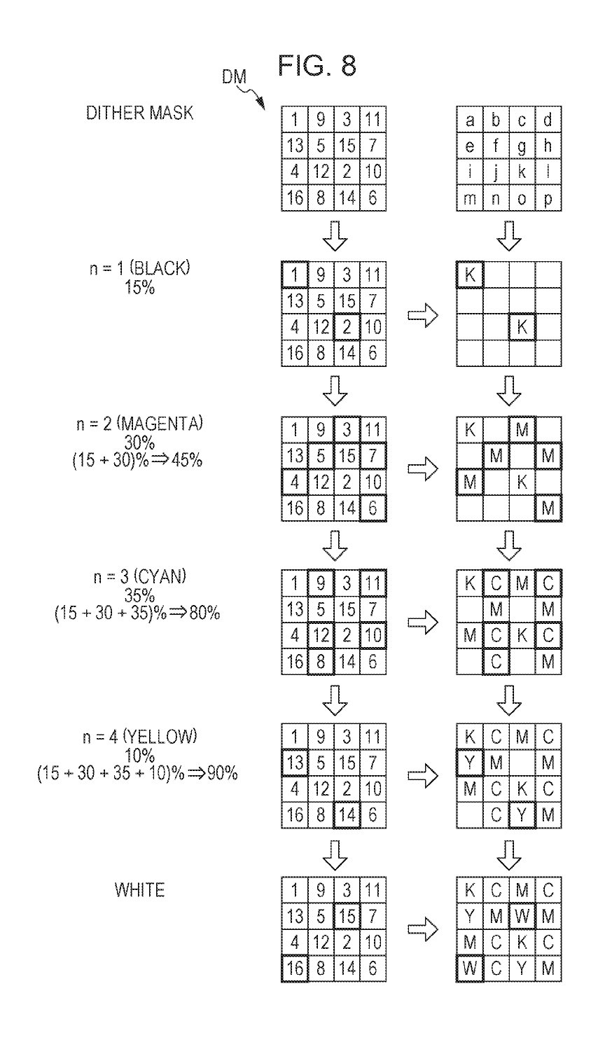

FIG. 8 is an explanatory diagram schematically illustrating the processing performed in steps S126 and S140. In this example, for the sake of simplification of description, the size of the dither mask DM is set to 4×4. Practically, a dither mask such as 64×64, 128×128 larger than that described in this embodiment is used. In this example, for the sake of convenience of description, the dot recording rate of each color normalized in step S122 of FIG. 7 is 15% for black, 30% for magenta, 35% for cyan, and 10% for yellow.

The dither mask DM has a size of 4×4, and different thresholds 1 to 16 are determined in advance for 16 voxels of the dither mask DM. It is to be noted that alphabet a to p labeled to the 4×4 cells at the upper right of FIG. 8 are symbols for specifying the voxels in the dither mask DM.

The discharge data generator 95 first determines voxels of the dither mask, to each of which a dot is assigned for black (n=1). The discharge data generator 95 calculates the total dot recording rate for the 1st time. In this example, n=1 indicates black, and the dot recording rate of black is 15%. Next, the discharge data generator 95 calculates a conversion value for the dot recording rate when 16 is assumed to be 100%. The discharge data generator 95 calculates a conversion value for the total dot recording rate by 16×15/100. In this example, the conversion value is 2.4. The discharge data generator 95 compares the conversion value of 2.4 with thresholds of 16 voxels, and assigns a dot of black to voxels having a threshold of 2.4 or less, specifically, the voxels a, k.

Next, the discharge data generator 95 first determines voxels of the dither mask, to each of which a dot is assigned for magenta (n=2). The discharge data generator 95 calculates the total dot recording rate up to the 2nd time. In this example, n=2 indicates magenta, and the dot recording rate of magenta is 30%. Therefore, the total dot recording rate up to the 2nd time is 45% (=(15+30)%). Next, the discharge data generator 95 calculates a conversion value for the total dot recording rate when 16 is assumed to be 100%. The discharge data generator 95 calculates a conversion value for the total dot recording rate by 16×45/100. In this example, the conversion value is 7.2. The discharge data generator 95 compares the conversion value of 7.2 with thresholds of 16 voxels, and assigns a dot of magenta to each voxel, to which a dot of black is not assigned, among the voxels having a threshold of 7.2 or less, specifically, the voxels c, f, h, i, and p.

Hereinafter, the discharge data generator 95 assigns a dot to each voxel in a similar manner, for cyan (n=3) and yellow (n=4). In this example, the discharge data generator 95 assigns a dot of cyan to the voxels b, d, j, l, and n, and assigns a dot of yellow to the voxels e, and o.

In this assignment, a dot of black, magenta, cyan, or yellow is not assigned to the voxels g, m. In the processing in step S140, the discharge data generator 95 assigns a dot of white ink to the voxels g, and m.

After the above processing, returning to FIG. 4, the CPU of the host computer 90 performs the processing in and after step S170. In step S170, the discharge data generator 95 generates modeling data FD to be sent to the three-dimensional object modeling device 10.

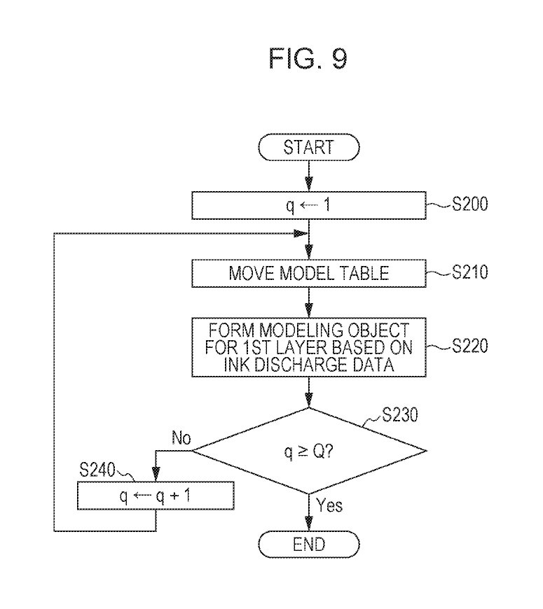

The host computer 90 outputs the modeling data FD to the three-dimensional object modeling device 10 at a predetermined timing. FIG. 9 is a flowchart illustrating model processing performed by the three-dimensional object modeling device 10. The processing is started when the three-dimensional object modeling device 10 receives the modeling data FD from the host computer 90. When the processing of FIG. 9 is started, the processing controller 15 substitutes 1 for variable q (step S200), where q is a variable that indicates the current layer number, and q=1 indicates the 1st layer from the lower side in the z direction. In the subsequent step S210, the processing controller 15 instructs the position change mechanism 17 to move the model table 45 to a height at which a model body of the 1st layer is formed. In step S220, the processing controller 15 forms a model body of the 1st layer based on ink discharge data (modeling data FD). Specifically, the processing controller 15 forms dots DT by discharging various types of ink onto the model table 45 through the nozzles Nz of the nozzle columns 33 to 38, and subsequently, solidifying the ink using the curing unit 61. In step S230, the processing controller 15 determines whether or not q≥Q. Q is the number of model body layers that form the three-dimensional object Obj. When q≥Q, generation of all the model bodies of the 1st to Qth layers is ended, and so generation of the three-dimensional object Obj is completed, thus the processing controller 15 completes the processing. On the other hand, when q<Q, the flow proceeds to step S240, and 1 is added to the variable q and the flow proceeds to step S210. In step S210 for the second time or later, the position change mechanism 17 lowers the model table 45 by the height Lz of the dot DT. Subsequently, the flow proceeds to step S220, and the same processing is repeated until q≥Q is satisfied in step S230.

According to this embodiment, the discharge data generator 95 performs normalization processing when performing the color conversion processing, and thus formation is limited to less than or equal to a unit thickness of modeling using the coloring ink and the modeling ink. Consequently, it is possible to reduce a possibility that the size of ink when the ink is cured exceeds the size of the three-dimensional object Obj to be modeled. Consequently, the color reproducibility can be improved while maintaining the shape reproducibility.

According to this embodiment, the discharge data generator 95 fills all the voxels in the color region with black, magenta, cyan, yellow, or white dots. That is to say, in the case of a light color, even when the amount use of black, magenta, cyan, and yellow ink is reduced, an insufficiency is filled by a white ink dot, thus both the shape reproducibility and the color reproducibility can be achieved.

According to this embodiment, a priority order is increased so that a dot of coloring ink with a lower brightness is assigned first, and thus, the color reproducibility can be further improved. It is to be noted that a dot of coloring ink with a lower brightness is not necessarily assigned first.

### Second Embodiment

In the first embodiment, the size of each dot discharged through the nozzles Nz has not been mentioned, and a description has been given under the assumption that each dot has the same size. In the second embodiment, three size dots including a large dot, a medium dot, and a small dot can be discharged through each nozzle Nz. The three-dimensional modeling device 10 can selectively discharge one of a large dot, a medium dot, and a small dot by changing the driving waveform signal generated by the driving signal generating part 31.

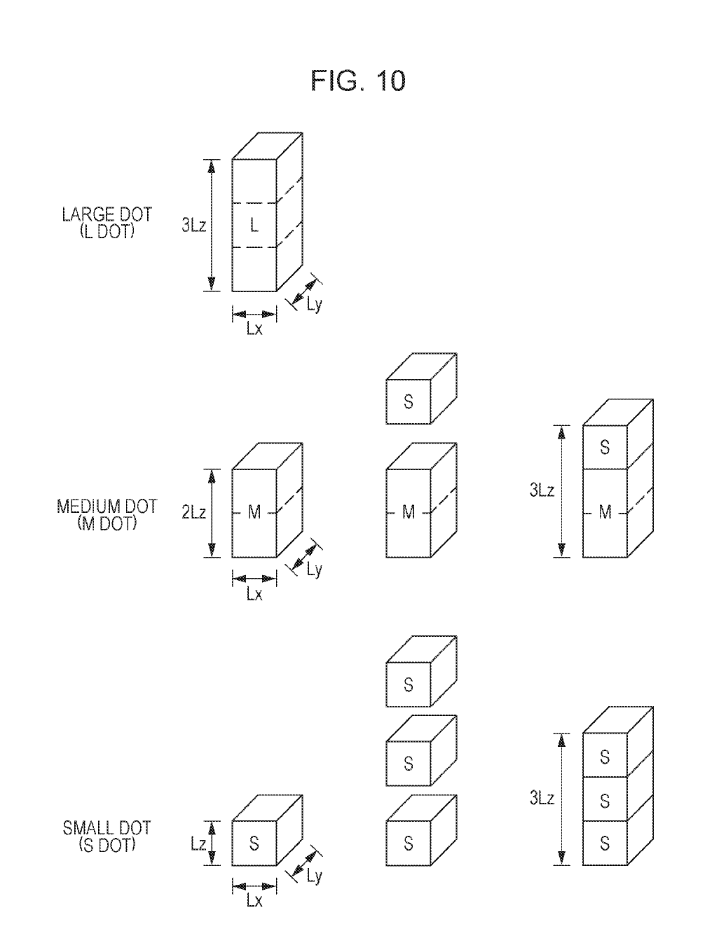

FIG. 10 is an explanatory diagram illustrating the sizes of dots in another embodiment. The small dot (S dot) has the size of Lx×Ly×Lz, the medium dot (M dot) has the size of Lx×Ly×2Lz, and the large dot (L dot) has the size of Lx×Ly×3Lz. The ratio of the sizes of the large dot, the medium dot, and the small dot is 3:2:1. Thus, when a small dot is discharged onto a medium dot sequentially, the same size of the large dot is obtained. Also, when three small dots are discharged sequentially or a medium dot is discharged onto a small dot sequentially (not illustrated), the size of the large dot is obtained.

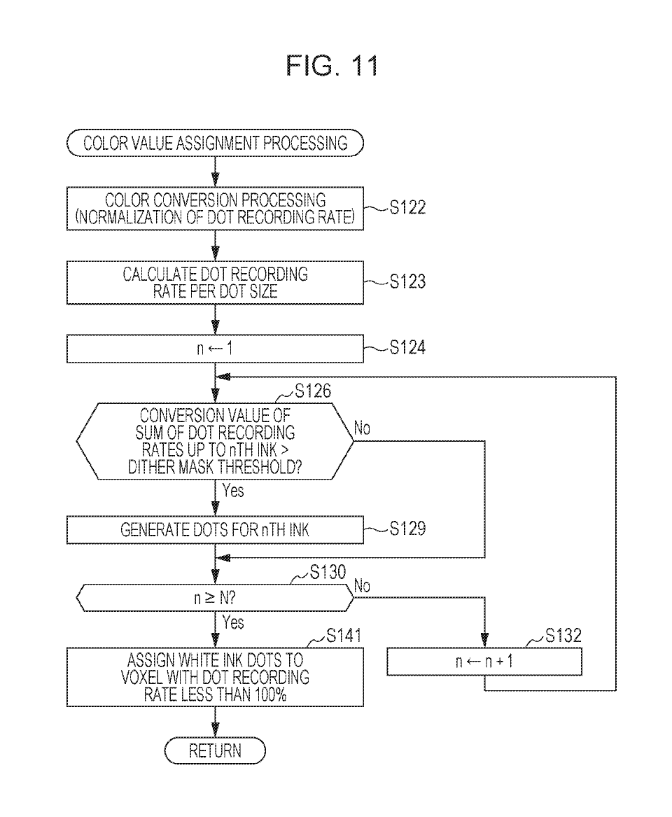

FIG. 11 is a flowchart of color value assignment processing performed by the discharge data generator 95. The difference between the flowcharts illustrated in FIGS. 7 and 11 is that step S123 is provided after step S122, and steps S129 and S141 are provided instead of steps S128 and 140. Hereinafter, the difference will be described.

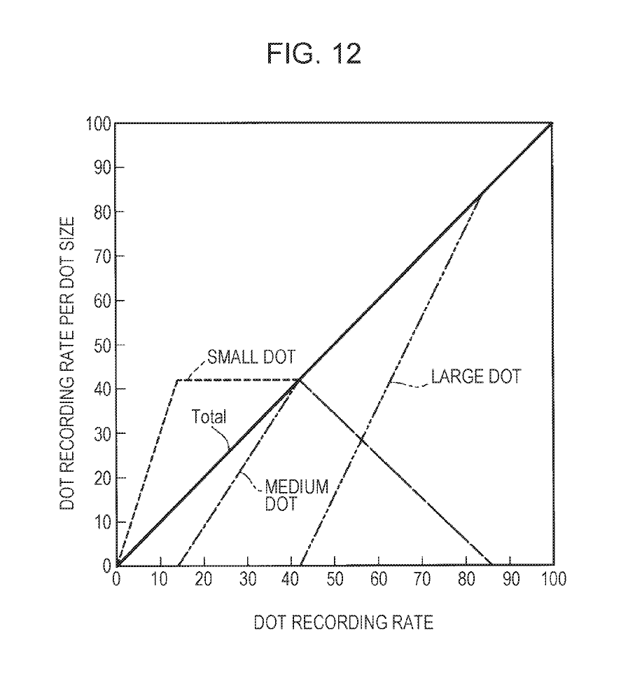

In step S123, the discharge data generator 95 calculates a dot recording rate for each dot size. FIG. 12 is an example of graph schematically illustrating the processing in step S123, performed by the discharge data generator 95. In FIG. 12, the horizontal axis indicates a normalized dot recording rate obtained in step S122, and the vertical axis indicates the dot recording rate of each of the large dot, the medium dot, and the small dot. The discharge data generator 95 calculates a normalized dot recording rate, and calculates a dot recording rate of each of the large dot, the medium dot, and the small dot in accordance with the graph of FIG. 12. In this embodiment, since the ratio of the sizes of the large dot, the medium dot, and the small dot is 3:2:1, the normalized dot recording rate=the total recording rate=the large dot recording rate+(the medium dot recording rate)/2+(the small dot recording rate)/3. The graph illustrated in FIG. 12 is an example, and when the color or the ratio of dot sizes is different, the shape of the graph is also different. Also, a conversion graph for dot recording rate per dot size of each color is created so that the sum of the large dot recording rates for all colors, and the sum of the large dot recording rates for all colors+the sum of (the medium dot recording rates for all colors)/2 do not exceed 100%.

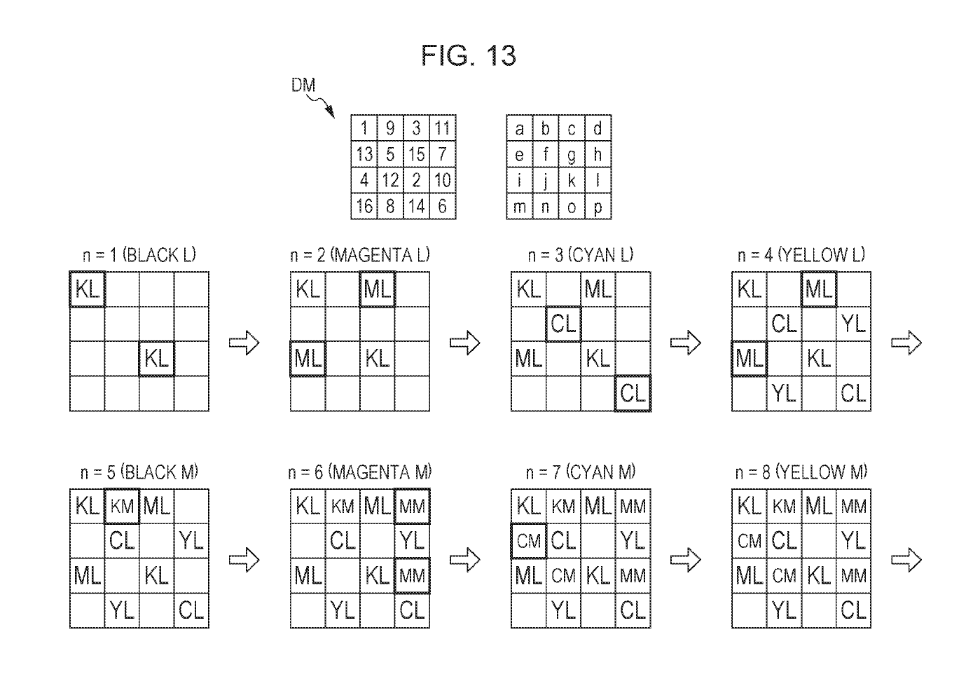

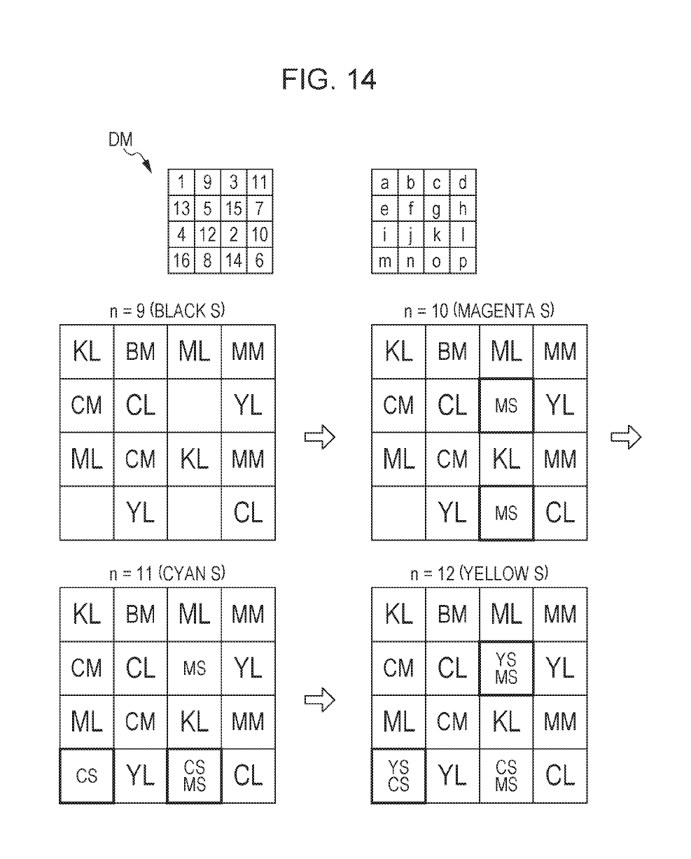

FIGS. 13 and 14 are each an explanatory diagram illustrating an example of dot generation processing in step S129 of FIG. 11, performed by the discharge data generator 95. FIG. 13 illustrates assignment of large dots and medium dots, and FIG. 14 illustrates assignment of small dots. It is to be noted that for the sake of convenience of description, FIGS. 13 and 14 do not illustrate the dot recording rates of the large to small dots for each color. Also, the dot recording rates of the large to small dots are not necessarily consistent with the values of the graph of FIG. 12. Similarly to what has been described with reference to FIG. 8, the conversion value of the total dot recording rate up to the nth time is compared with a threshold of the dither mask, and the voxel is filled with dots. The order at this point is as follows: large dot of black (n=1)=>large dot of magenta (n=2)=>large dot of cyan (n=3)=>large dot of yellow (n=4)=>medium dot of black (n=5)=>medium dot of magenta (n=6)=>medium dot of cyan (n=7)=>medium dot of yellow (n=8)=>small dot of black (n=9)=>small dot of magenta (n=10)=>small dot of cyan (n=11)=>small dot of yellow (n=12). The reason why the priority order of discharge with a large dot is set higher than the priority order of coloring ink with a lower brightness is that the color reproducibility can be further improved. In this embodiment, a conversion graph for dot recording rate per dot size of each color is created so that the sum of the large dot recording rates for all colors, and the sum of the large dot recording rates for all colors+the sum of (the medium dot recording rates for all colors)/2 do not exceed 100%, and thus similarly to what has been described with reference to FIG. 6, a large dot, a medium dot for each color can be assigned to a free voxel until assignment of a medium dot of yellow for n=8 illustrated in FIG. 13. In the example of FIG. 13, after the assignment of a medium dot of yellow, no dot is assigned to three voxels g, m, o.

In FIG. 14, the discharge data generator 95 first assigns a small dot of black for n=9. A small dot of black is assigned based on comparison of the conversion value of the total dot recording rate up to the 9th ink with a threshold of the dither mask DM. In this example, since no voxel is present, to which a small dot of black is assigned, the discharge data generator 95 does not assign a small dot of black.

Next, the discharge data generator 95 assigns a small dot of magenta for n=10. The discharge data generator 95 assigns a small dot of magenta to the voxels g, o based on comparison of the conversion value of the total dot recording rate up to the 10th ink with a threshold of the dither mask DM.

Next, the discharge data generator 95 assigns a small dot of cyan for n=11. In this example, the total dot recording rate up to the 11th ink exceeds 100%, and thus the discharge data generator 95 assigns a dot as follows. The discharge data generator 95 adds the dot recording rate of a small dot of cyan for n=11 to the total value of the dot recording rates of ink for large dots to medium dots until n=8, and compares the conversion value with a threshold of the dither mask DM, and assigns a small dot of cyan to each voxel excluding the voxels to which a large dot or a medium dot is already assigned. In this stage, a voxel, to which a dot is assigned, may overlap. Subsequently, when there is a voxel to which a dot has not been assigned, a small dot assigned to a voxel having a higher threshold of the dither mask DM among voxels to which a small dot is duplicately assigned is reassigned to the voxel to which a dot has not been assigned. In this example, the discharge data generator 95 first assigns a small dot of cyan to the voxels g, o. However, no dot is assigned to the voxel m. Therefore, the discharge data generator 95 reassigns a small dot of cyan to the voxel m, the small dot of cyan being assigned to the voxel g having a higher threshold between the voxels g, o.

Next, the discharge data generator 95 assigns a small dot of yellow for n=12. In this case, a dot is assigned to each voxel, and thus the discharge data generator 95 similarly adds the dot recording rate of a small dot of yellow for n=12 to the total value of the dot recording rates of ink for medium dots until n=8, and compares the conversion value with a threshold of the dither mask DM, and duplicately assigns a small dot of yellow to each voxel excluding the voxels to which a large dot or a medium dot is already assigned. The discharge data generator 95 first assigns a small dot of yellow to the voxels g, o. Next, the discharge data generator 95 determines whether or not there is a voxel to which three small dots are assigned. Since the ink of three small dots of magenta, cyan, and yellow is assigned to the voxel o, a dot of yellow assigned finally is reassigned in the order to a voxel having a lower threshold of the dither mask DM among voxels to which only one small dot is assigned. In this example, the discharge data generator 95 reassigns a small dot of yellow of the voxel o to the voxel m. The discharge data generator 95 repeats the processing until there is no dot to which the ink of three small dots is assigned. However, even in the case where there is a dot to which the ink of three small dots is assigned, when only those voxels are present, to which two small dots are assigned, in other voxels excluding the voxels to which a large dot is assigned and the voxels to which a medium dot is assigned, the discharge data generator 95 does not reassign a small dot. This is because each voxel for assignment has three small dots.

Next, the discharge data generator 95 performs processing of substantially equalizing the amount of ink of each voxel. In step S141 of FIG. 11, the discharge data generator 95 assigns a dot of white ink to each voxel having a dot recording rate lower than 100%. Specifically, the discharge data generator 95 duplicately assigns a small dot of white ink to a voxel to which a medium dot is assigned, duplicately assigns a medium dot of white ink to a voxel to which one small dot is assigned, and duplicately assigns a small dot of white ink to a voxel to which two small dots are assigned. Thus, the size of all the voxels can be substantially equally to the size of the large dots.

Consequently, according to this embodiment, similarly to the first embodiment, even when the sizes of dots formed in the coloring ink are different, the color reproducibility can be improved while maintaining the shape reproducibility.

According to this embodiment, the priority order of coloring ink with a lower brightness is increased, and thus the color reproducibility can be improved.

According to this embodiment, the priority order of discharge with a large dot is set higher than the priority order of coloring ink with a lower brightness, and thus the color reproducibility can be further improved.

### Other Modifications

The present technique is applicable to a three-dimensional object modeling device that uses a liquid other than cyan ink, magenta ink, yellow ink, white ink, black ink, and clear ink, for instance. For instance, gray ink, metallic ink (ink that exhibits metallic luster) are also usable. It goes without saying that the present technique is also applicable to a three-dimensional object modeling device that does not use part of cyan ink, magenta ink, yellow ink, white ink, black ink, gray ink, metallic ink, and clear ink. Multiple types of dots formed by a dot formation unit may include dots with one of more colors of cyan, magenta, yellow, black, white, gray, and metallic color.

The ink discharged from the head unit may be a thermoplastic liquid such as a thermoplastic resin. In this case, the head unit may heat and discharge the liquid in a molten state. Also, the curing unit may be a section of the three-dimensional object modeling device, in which a dot with liquid from the head unit is cooled and solidified. In the present technique, “curing” includes “solidifying”. Also, the modeling ink and the supporting ink may use liquids having different types of curing/solidifying process. For instance, an ultraviolet curable resin may be used for the modeling ink, and a thermoplastic resin may be used for the supporting ink.

The curing unit 61 may be mounted in the carriage.

A model processing device may forms a model layer by solidifying powder materials covered in layers using a curable liquid, and may model a three-dimensional object by stacking the formed model layer.

Also, the three-dimensional object modeling device is not limited to an inkjet device that discharges liquid and forms dots, and may be an optical model device that forms cured dots by irradiating a tank filled with an ultraviolet curable liquid resin with an ultraviolet laser, or a sintered powder lamination device that forms sintered dots by irradiating powder materials with a high-output laser beam.

It is to be noted that in the embodiments, dots are formed to be flat with one layer. However, dots may be formed to be flat with two layers. For instance, when dots are formed to be flat with two layers, in a stage where the first layer is formed, the dots may have projections and depressions. Also, at a position where a projection occurs when the first layer is formed, dots may formed to have a depression when the second layer is formed, and at a position where a depression occurs when the first layer is formed, dots may formed to have a projection when the second layer is formed. A flat surface is obtained by compensating a projection and a depression. It is to be noted that dots may be formed to be flat with three or more layers.

Also, a configuration obtained by mutually replacing or changing a combination of the configurations disclosed in the example described above, and a configuration obtained by mutually replacing or changing a combination of a publicly known technique and the configurations disclosed in the example described above are also practicable. The invention also includes these configurations.

The entire disclosure of Japanese Patent Application No. 2017-062246, filed Mar. 28, 2017 is expressly incorporated by reference herein.

What is claimed is:

1. A three-dimensional object modeling device that uses ink which is solidified after being discharged and becomes part of a three-dimensional object as a three-dimensional dot, the three-dimensional object modeling device comprising:
a first nozzle that allows a modeling ink in the ink to be discharged, the modeling ink being used for modeling the three-dimensional object;
a second nozzle that allows a coloring ink in the ink to be discharged, the coloring ink being used for coloring the three-dimensional object;
a model data generator that generates model data including a color of the three-dimensional object;
a region determiner that determines a color region to be colored by discharge of the coloring ink through the second nozzle, and a model region that is inwardly of the color region and to be modeled by discharge of the modeling ink through the first nozzle, based on the generated model data;
a first discharge data generator that generates discharge data of the modeling ink for discharging the modeling ink in the model region;
a second discharge data generator that generates discharge data of the coloring ink while limiting formation of the dot with the coloring ink in the color region to less than or equal to a unit thickness of modeling using the coloring ink and the modeling ink; and
a processing controller that causes the modeling ink and the coloring ink to be discharged though the first and second nozzles using the generated discharge data of the modeling ink and the generated discharge data of the coloring ink.

2. The three-dimensional object modeling device according to claim 1,
wherein the second nozzle comprises a plurality of second nozzles for discharging a plurality of coloring inks having different hues, the coloring ink being one of the plurality of coloring inks, and
the second discharge data generator determines the formation of the dot with the coloring ink in accordance with a predetermined priority order of the plurality of coloring inks having different hues.

3. The three-dimensional object modeling device according to claim 2,
wherein the second discharge data generator assigns a higher priority order to a coloring ink with a lower brightness among the plurality of coloring inks having different hues.

4. The three-dimensional object modeling device according to claim 3,
wherein the second nozzle allows the plurality of coloring inks to be discharged coping with dots in a plurality of sizes, and
the second discharge data generator assigns a priority order to discharge coping with a large dot among the dots in the plurality of sizes, the priority order being higher than the priority order of the coloring ink with a lower brightness.

5. The three-dimensional object modeling device according to claim 1,
wherein the second discharge data generator determines a dot to be layered in the color region, by halftone processing so that a predetermined amount of ink or less is used for the dot, and
when an amount of ink layered in the color region is less than the predetermined amount of ink, the second discharge data generator determines to fill an insufficiency with ink other than the coloring ink.

6. A method of molding a three-dimensional object, the method comprising:
generating model data including a color of the three-dimensional object;
determining a color region to be colored by discharge of the coloring ink, and a model region that is inwardly of the color region and to be modeled by discharge of the modeling ink, based on the generated model data;
generating discharge data of the modeling ink for discharging the modeling ink in the model region;
generating discharge data of the coloring ink while limiting formation of the dot with the coloring ink in the color region to less than or equal to a unit thickness of modeling using the coloring ink and the modeling ink; and
discharging the modeling ink and the coloring ink, and performing modeling and coloring of the three-dimensional object.

7. The method of molding a three-dimensional object according to claim 6,
wherein the discharge of the coloring ink is discharge of a plurality of coloring inks having different hues, and
the formation of the dot with the coloring ink is determined in accordance with a predetermined priority order of the plurality of coloring inks having different hues.

8. The method of molding a three-dimensional object according to claim 7,
wherein a higher priority order is assigned to a coloring ink with a lower brightness among the plurality of coloring inks having different hues for discharging the plurality of coloring inks having different hues.

9. The method of molding a three-dimensional object according to claim 8,
wherein the coloring ink is allowed to be discharged coping with dots in a plurality of sizes, and
a priority order is assigned to discharge coping with a large dot among the dots in the plurality of sizes, the priority order being higher than the priority order of the coloring ink with a lower brightness.

10. The method of molding a three-dimensional object according to claim 6,
wherein a dot to be layered in the color region is determined by halftone processing so that a predetermined amount of ink or less is used for the dot, and
when an amount of ink layered in the color region is less than the predetermined amount of ink, it is determined that an insufficiency is filled by ink other than the coloring ink.

11. A control program for a three-dimensional object modeling device, the control program causing a computer to implement a function, the function comprising:
generating model data including a color of the three-dimensional object;
determining a color region to be colored by discharge of the coloring ink, and a model region that is inwardly of the color region and to be modeled by discharge of the modeling ink, based on the generated model data;
generating discharge data of the modeling ink for discharging the modeling ink in the model region;
generating discharge data of the coloring ink while limiting formation of the dot with the coloring ink in the color region to less than or equal to a unit thickness of modeling using the coloring ink and the modeling ink; and
discharging the modeling ink and the coloring ink, and performing modeling and coloring of the three-dimensional object.
